(19) United States
(12) Patent Application Publication
(10) Pub. No.: US 2009/0201455 A1
(43) Pub. Date: Aug. 13, 2009

(54) ACTIVE MATRIX SUBSTRATE AND LIQUID CRYSTAL DISPLAY DEVICE PROVIDED WITH SAME

(75) Inventor: Atsuhito Murai, Tokyo (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/301,651

(22) PCT Filed: May 8, 2007
(86) PCT No.: PCT/JP2007/059513

§ 371 Date: Nov. 20, 2008

(30) Foreign Application Priority Data
Sep. 27, 2006 (JP) 2006-263506

(51) Int. Cl. G02F 1/1343

(52) U.S. Cl. 349/139

(57) ABSTRACT

An active matrix substrate includes an insulating substrate, gate wires and source wires that intersect with each other on the insulating substrate, and TFTs provided at intersections of signal lines. The TFTs include gate electrodes, source electrodes and drain electrodes, respectively. A transparent conductive film, which is arranged to be used as a lower layer of the sources and the drains, is used as common electrodes for pixel areas surrounded by adjacent source wires, and also common electrode wires arranged to connect adjacent ones of the common electrodes parallel or substantially parallel to the source wires. This provides an active matrix substrate in which a signal delay caused by resistance and parasitic capacitance is reduced.

### BACKGROUND OF THE INVENTION

1. Field of the Invention

The present invention relates to an active matrix substrate which incorporates a TFT, and a liquid crystal display device including the active matrix substrate.

2. Description of the Related Art

Liquid crystal display devices of an FFS (Fringe Field Switching) mode have been known in the art. A liquid crystal display device of the FFS mode is arranged such that a counter electrode and a pixel electrode (i) are formed by transparent material such as ITO, (ii) have a narrower space between the counter electrode and the pixel electrode than a space between the upper and lower substrates, and (iii) have a width between the counter electrode and the pixel electrode in a degree in which all of liquid molecules aligned on an upper part of an electrode are drivable.

The liquid crystal display device of the FFS mode can attain a higher aperture ratio than that of a liquid crystal display device of an IPS (In-Place-Switching) mode, since the electrodes and the like are formed by the transparent material. That is to say, a higher aperture ratio than that of the IPS mode is attainable by causing light transmission to occur at an electrode section.

FIG. 21A is a plane view of an active matrix substrate to be used in a liquid crystal display device of the FFS mode, as described in Japanese Unexamined Patent Publication Tokukai 2001-235763, and FIG. 21B is a cross sectional view taken along line A-A′ indicated in FIG. 21A.

As illustrated in FIG. 21A, the active matrix substrate mainly includes a plurality of gate bus lines 101 and a plurality of source bus lines 107 which orthogonally intersect with each other, a plurality of pixel electrodes 109 arranged in a comb-like shape and parallel to the source bus lines 107 in pixel areas surrounded by the gate and source bus lines, respectively, TFTs 103 provided on sections in which the gate bus lines 101 diverge to the pixel area side, and common electrode wires (CS wires) 110 provided parallel to the gate bus lines 101.

Further, as illustrated in FIG. 21B, the active matrix substrate has common electrodes (gate bus line lower layer) 106 which consist of a transparent conductive film on an insulating substrate. Further, on the common electrodes 106 are provided a gate bus line upper layer 101 and CS wires 110. Moreover, a semiconductor layer 103, a contact layer 104, and a source/drain electrode upper layer 107 are stacked on the gate bus line upper layer 101 sandwiching a gate insulating film 102 between the semiconductor layer 103 and the gate bus line upper layer 101, so as to form a TFT. On an uppermost layer of the active matrix substrate is provided pixel electrodes 109 via an interlayer insulating film (passivation film) 108.

The active matrix substrate described in Japanese Unexamined Patent Publication Tokukai 2001-235763 has the following two problems caused by the common electrodes which form the CS wires 110 being provided on the gate bus line lower layer 106.

Namely, as illustrated in FIG. 22, roughening of the common electrodes and the gate bus line upper layer causes the semiconductor layer 103, the contact layer 104, and the source/drain electrode upper layer 107 that are provided on the gate insulating film 102, to also be rough. Note that the semiconductor layer 103, the contact layer 104, and the source/drain electrode upper layer 107 form a channel section 111 of the TFT. Particularly, in a case where a common transparent metal film is used as transparent electrodes, the flatness decreases. This causes the roughness of the channel section 111 of the TFT to increase. As a result, a problem of a decrease in mobility occurs.

Moreover, the transparent electrodes have an extremely low transition temperature of crystallization, that is, the transparent electrodes polysiliconize (crystallize) from an amorphous state at around a temperature in a range of 150° C. to 200° C. When the transparent electrodes are compared between a crystallized state and the amorphous state, a large difference is recognized in an etching rate. Therefore, polysiliconization of the transparent electrodes causes a need to etch for a remarkably long period of time. Namely, as illustrated in FIG. 23, over-etching is required. As a result, the gate bus lines 101 become tapered towards the back (peaked), and the gate insulating film 102 cannot cover the gate bus lines 101. This causes a problem that an efficiency percentage decreases, such as occurrence of leaking from the metal thin film formed on the upper layer.

An active matrix substrate described in Japanese Unexamined Patent Publication Tokukai 2002-90781 provides common electrodes on a gate insulating film. In other words, the common electrodes are provided on a layer upper than the gate bus lines. Therefore, the two aforementioned problems are solved.

However, Japanese Unexamined Patent Publication Tokukai 2001-235763 and Japanese Unexamined Patent Publication Tokukai 2002-90781 both form the common electrodes parallel to the gate bus lines by use of a metal layer of the gate bus lines arranged horizontally to the liquid crystal display section. That is to say, the CS wires 123 are horizontally provided, as illustrated in FIG. 24. Generally, in liquid crystal display devices, many liquid crystal display sections are relatively wide. Therefore, the gate bus lines are longer as compared to the source bus lines. Consequently, the common electrodes formed at the CS wires 123 have a high resistance, which causes a problem of signal delay. However, in order to solve this problem, if a width of the CS wires 123 is thickened so as to aim for a low resistance, another problem occurs that an aperture ratio decreases.

In response to this, International Patent Publication No. WO 01/18597 provides the common electrodes (transparent electrode material, for example ITO) on a higher position than the pixel electrodes, as illustrated in FIG. 25. The transparent electrode material is left remaining on all of an area except for a slit section of the common electrodes, so as to form the common electrodes. Further, as illustrated in FIG. 26, the transparent electrode material (CS wires) is provided on substantially the entire source bus lines and gate bus lines. As such, the problem of signal delay is solved by providing the CS wires parallel to the source bus lines.

Other prior art devices are disclosed in Japanese Unexamined Patent Publication No. 221992/2001 (Tokukai 2001-221992) and Japanese Unexamined Patent Publication No. 230380/1997 (Tokukaihei 9-230380).

However, in the technique disclosed in International Patent Publication No. WO 01/18597, the CS wires are arranged so as to cover the entire source bus lines and gate bus lines illustrated in FIG. 26. Therefore, defects such as a shortage and the like may possibly occur, and a parasitic capacitance between the gate and source bus lines and the CS wires increases.

### SUMMARY OF THE INVENTION

In view of the problems described above, preferred embodiments of the present invention provide an active matrix substrate and a liquid crystal display device including the same that has both a decreased signal delay caused by resistance and a decreased signal delay caused by parasitic capacitance.

An active matrix substrate according to preferred embodiments of the present invention includes an insulating substrate, video signal lines and scanning signal lines arranged to intersect with each other on the insulating substrate, and thin film transistors provided at intersections of the video signal lines and the scanning signal lines. The thin film transistors including gate electrodes, source electrodes, and drain electrodes, respectively, a transparent electrode layer, arranged to be used as a lower layer of the source electrodes and the drain electrodes, being used as (i) common electrodes provided in pixel areas surrounded by adjacent video signal lines and adjacent scanning signal lines, respectively, and (ii) common electrode wires arranged to connect adjacent ones of the common electrodes parallel or substantially parallel to the video signal lines.

According to the arrangement, a transparent electrode layer that is arranged to be used as a lower layer of source electrodes and drain electrodes is used as (i) common electrodes provided in pixel areas surrounded by adjacent video signal lines and adjacent scanning signal lines, respectively, and (ii) common electrode wires arranged to connect adjacent ones of the common electrodes parallel to the video signal lines. In other words, the common electrodes and the common electrode wires are arranged to use the transparent electrode layer that is to be used as a lower layer of the source electrodes and the drain electrodes. This allows the common electrodes to be connected and extended in a parallel or substantially parallel direction to the video signal lines that are connected to the source electrodes. Generally, video signal lines are shorter than the scanning signal lines. Therefore, it is possible to reduce resistance as compared to the common electrodes.

Furthermore, according to the above arrangement, the common electrode wires do not have any portion overlapping with the video signal lines, and are arranged to overlap at a portion where the common electrode wires intersect with the scanning signal lines. When focused on one common electrode that is arranged between adjacent video signal lines, generally a number of video signal lines is more than that of the scanning signal lines (for example, video signal lines:scanning signal lines=3 (RGB):1). Therefore, a number of overlapping portions of the common electrodes and each signal lines (video signal lines, scanning signal lines) is reduced as compared to a conventional arrangement in which the common electrodes overlap at the portions that intersect with the video signal lines. As a result, the parasitic capacitance of the common electrode wires is reduced.

As described above, a preferred embodiment of the present invention reduces the resistance of the common electrodes and the common electrode wires, as well as reducing the parasitic capacitance between the common electrode wires and the signal lines. Therefore, it is possible to reduce the signal delay of the common electrode wires.

Further, according to the above arrangement, a transparent electrode layer (transparent conductive material such as ITO) is arranged as a lower layer of the source electrodes and the drain electrodes. This allows for formation of the common electrodes in a same photolithography step as the formation of the source electrodes and the drain electrodes by use of a photolithography step that utilizes so-called halftone exposure. As a result, simplification of a manufacturing method is possible. In addition, since the common electrodes are formable in the same photolithography step, a decrease in yield rate caused by the photo alignment disposition and decrease in aperture ratio are prevented as compared to formation of the source and drain electrodes in a different photo step to the common electrodes, as in Japanese Unexamined Patent Publication Tokukai 2002-90781, described above.

An active matrix substrate according to a preferred embodiment of the present invention is preferably arranged such that a metal film arranged to create the gate electrodes is used as auxiliary common electrode wires that are arranged parallel or substantially parallel to the scanning signal lines, and the auxiliary common electrode wires and the common electrodes are electrically connected to each other via contact holes, respectively.

According to the above arrangement, auxiliary common electrode wires are arranged parallel or substantially in parallel to the scanning signal lines, and the auxiliary common electrode wires and the common electrodes are electrically connected to each other via contact holes, respectively, provided on the gate insulating film. That is to say, a reticulate structure is provided by use of the common electrodes, common electrode wires and the auxiliary common electrode wires. Therefore, it is possible to have the structure close to one in which a resistance is determined just by an aspect ratio (concept of sheet resistance), regardless of its size and material. Therefore, it is possible to reduce the resistance between two arbitrary points. Further, in the technique described in Japanese Unexamined Patent Publication Tokukai 2002-90781, the common electrodes 120 and the common electrode wires 121 are connected to each other via source metals (metal layer of source bus lines) 122 as illustrated in FIG. 27. This causes a problem of pixel defects in a case where ohmic contact cannot be made. However, the reticulate structure enables the common electrodes to have four-directional redundancy. Therefore, even if a pixel that cannot make the ohmic contact, or, further even if one of the common electrodes and/or the auxiliary common electrodes have a breakage, pixel defects and line defects are prevented to the utmost.

An active matrix substrate according to a preferred embodiment of the present invention is preferably arranged such that each of the common electrodes has an opening section having first and second end sections that are located outside and inside, respectively, of an outer edge of a respective one of the contact holes, and contact electrode pads connected to (i) the auxiliary common electrode wires on the first end sections side of the common electrodes, and (ii) the common electrodes on the second end sections side of the common electrodes, respectively.

According to the above arrangement, each of the common electrodes has an opening whose first and second end sections are located outside and inside, respectively, of an outer edge of a respective one of the contact holes, and contact electrode pads are connected to (i) the auxiliary common electrode wires on the first end sections side of the common electrodes, and (ii) the common electrodes on the second end sections side of the common electrodes, respectively. This enables electrical connection between the common electrodes and the auxiliary common electrode wires by use of the contact electrode pads. Moreover, this allows for elimination of a contact hole forming step for connecting the common electrodes and the auxiliary common electrode wires, which forming step is to be carried out before formation of the source wires/electrodes and the drain electrodes.

An active matrix substrate according to a preferred embodiment of the present invention is preferably arranged such that the pixel areas include pixel electrodes, and the contact electrode pads are formed to be made of a same material and in a same manufacturing step as the pixel electrodes.

According to the above arrangement, pixel electrodes and contact pads are formed by a same material and in a same manufacturing step. This allows for a simplification of a manufacturing method.

An active matrix substrate according to a preferred embodiment of the present invention is preferably arranged such that the auxiliary common electrode wires are provided substantially at a midpoint between adjacent ones of the scanning signal lines, respectively.

According to the above arrangement, the auxiliary common electrode wires are provided substantially at a midpoint between adjacent ones of the scanning signal lines. The auxiliary common electrode wires are arranged parallel or substantially parallel to the scanning signal lines. Therefore, by providing the auxiliary common electrode wires substantially at a midpoint between the adjacent ones of the scanning signal lines, a distance between the auxiliary common electrode wires and the scanning signal lines is maximized. A longer distance from the auxiliary common electrode wires to the scanning signal line reduces a possibility of a shortage in the auxiliary common electrode wires and the scanning signal lines due to poor patterns and adherence of dust.

An active matrix substrate according to a preferred embodiment of the present invention is preferably arranged such that the auxiliary common electrode wires are provided in a vicinity of one of adjacent ones of the scanning signal lines.

According to the above arrangement, the auxiliary common electrode wires are provided in a vicinity of one of the adjacent ones of the scanning signal lines. In the vicinity of the scanning signal lines is an area that does not contribute to an aperture. Therefore, it is possible to realize a high aperture ratio since portions of the auxiliary common electrode wires are provided on the area which does not contribute to the aperture.

An active matrix substrate according to a preferred embodiment of the present invention is preferably arranged such that the auxiliary common electrode wires extend to outer peripheral sections of the common electrodes, and extend in the outer peripheral sections so as to be parallel or substantially parallel to the video signal lines, respectively.

The outer peripheral section of the common electrode has a so-called disabled area (an area in which liquid crystal does not move, and a liquid crystal domain occurrence area). According to a preferred embodiment of the present invention, the auxiliary common electrode wires extend to the outer peripheral section of the common electrodes and extend in the outer peripheral sections so as to be parallel or substantially parallel to the video signal lines, respectively. Therefore, light shielding of the disabled area is carried out by the auxiliary common electrode wires, therefore allows for attainment of a high display quality.

An active matrix substrate according to a preferred embodiment of the present invention is preferably arranged such that the auxiliary common electrode wires also extend to the outer peripheral sections of the common electrodes, and extend in the outer peripheral sections so as to be parallel or substantially parallel to the scanning signal lines, respectively.

According to the above arrangement, it is possible to reduce resistance of the auxiliary common electrode wires and shield light from the disabled area of the scanning signal lines.

An active matrix substrate according to a preferred embodiment of the present invention is preferably arranged such that a metal layer is arranged to surround outer peripheries of the common electrodes, the metal layer being stacked to be used as an upper layer of the source electrodes and the drain electrodes.

According to the above arrangement, a stacked metal layer used as an upper layer of the source electrodes and the drain electrodes is arranged to surround outer peripheries of the common electrodes. This allows the outer peripheries of the common electrodes to have a light shielding function, and the resistance between the common electrodes and the auxiliary common electrode wires is reduced.

An active matrix substrate according to a preferred embodiment of the present invention is preferably arranged such that the metal layer is provided on portions on which the common electrode wires are provided.

In addition, the active matrix substrate of the above preferred embodiment is preferably arranged such that a metal layer is provided on intersections of the common electrode wires and the scanning signal lines.

According to the above arrangement, a metal layer is provided on intersections of the common electrode wires and the scanning signal lines. Therefore, it is possible to reduce the resistance of the common electrode wires. Further, the common electrode wires are of a stacked structure having the transparent electrode layer and the metal layer. This enables reduction of malfunction in the intersecting section with the scanning signal line such as breakage.

An active matrix substrate according to a preferred embodiment of the present invention further preferably includes an interlayer insulating film including at least two layers, the two layers being a layer composed of an inorganic film and a layer composed of a low dielectric constant organic material.

Here, low dielectric constant organic material denotes, for example, a material having a dielectric constant of not more than about 5. According to this arrangement, an interlayer insulating film includes at least two layers, a layer of inorganic film and a layer of low dielectric constant organic material. Providing the low dielectric constant organic material enables decreasing of the parasitic capacitance. Further, by arranging the interlayer insulating film as having at least two layers, defects such as leakage is reduced. As a result, high reliability is realized.

A liquid crystal display device according to a preferred embodiment of the present invention preferably includes any one of the foregoing active matrix substrates.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIGS. 1A and 1B are cross sectional views illustrating one pixel area of an active matrix substrate of a preferred embodiment in the present invention, wherein FIG. 1A is a cross sectional view taken along a line A-A′ as indicated in FIG. 2, and FIG. 1B is a cross sectional view taken along a line B-B′ as indicated in FIG. 2.

FIG. 2 is a plane view illustrating one pixel area in an active matrix substrate of the preferred embodiment shown in FIGS. 1A and 1B.

FIGS. 3A-3I are cross sectional views illustrating a manufacturing process of an active matrix substrate of the preferred embodiment shown in FIGS. 1A and 1B.

FIGS. 4A and 4B are cross sectional views illustrating a preferred embodiment, wherein FIG. 4A is a cross sectional view corresponding to the line A-A′ in FIG. 1A, and FIG. 4B is a cross sectional view corresponding to the line B-B′ in FIG. 1B.

FIG. 5 illustrates a preferred embodiment of the present invention, and is a plane view corresponding to a modification of FIG. 2.

FIGS. 6A and 6B are cross sectional views illustrating a preferred embodiment of the present invention, wherein FIG. 6A is a cross sectional view taken along a line A-A′ as indicated in FIG. 5, and FIG. 6B is a cross sectional view taken along a line B-B′ as indicated in FIG. 5.

FIG. 7 illustrates a preferred embodiment of the present invention, corresponding to a modification of FIG. 2.

FIGS. 8A and 8B are cross sectional views illustrating a preferred embodiment of the present invention, wherein FIG. 8A is a cross sectional view taken along a line A-A′ as indicated in FIG. 7, and FIG. 8B is a cross sectional view taken along a line B-B′ as indicated in FIG. 7.

FIG. 9 illustrates a preferred embodiment of the present invention, corresponding to a modification of FIG. 2.

FIGS. 10A and 10B are cross sectional views illustrating a preferred embodiment of the present invention, wherein FIG. 10A is a cross sectional view taken along a line A-A′ as indicated in FIG. 9, and FIG. 10B is a cross sectional view taken along a line B-B′ as indicated in FIG. 9.

FIG. 11 illustrates a preferred embodiment of the present invention, corresponding to a modification of FIG. 2.

FIG. 12 illustrates a preferred embodiment of the present invention, and is a cross sectional view taken along a line A-A′ as indicated in FIG. 11.

FIG. 13 illustrates a preferred embodiment of the present invention, and is an enlarged view of a section C illustrated in FIG. 3, that is, an intersecting section of a common electrode and auxiliary common electrode wires.

FIG. 14 illustrates a preferred embodiment of the present invention, and is a cross sectional view taken along a line B-B′ as indicated in FIG. 13.

FIGS. 15A-15I are cross sectional views illustrating a manufacturing process of an active matrix substrate of a preferred embodiment of the active matrix substrate illustrated in FIG. 12.

FIGS. 16A-16J illustrate a preferred embodiment of the present invention, and are cross sectional views and plane views illustrating a formation method of a contact section in a six-mask process, wherein FIGS. 16A-16E are cross sectional views, and FIGS. 16F-16J are plane views.

FIGS. 17A-17J illustrate a preferred embodiment of the present invention, and are cross sectional views and a plane views illustrating a formation method of a contact section in a five-mask process, wherein FIGS. 17A-17E are cross sectional views, and FIGS. 17F-17J are plane views.

FIGS. 18A and 18B are a plane view and a cross sectional view of a comparative example of FIGS. 13 and 14 that illustrate a preferred embodiment of the present invention, wherein FIG. 18A is a plane view, and FIG. 18B is a cross sectional view.

FIGS. 19A and 19B are a plane view and a cross sectional view of a comparative example of FIGS. 13 and 14 that illustrate a preferred embodiment of the present invention, wherein FIG. 19A is a plane view, and FIG. 19B is a cross sectional view.

FIGS. 20A and 20B are plane views of a preferred embodiment of the present invention, wherein FIG. 20A and FIG. 20B are plane views corresponding to a modification of FIG. 2.

FIGS. 21A and 21B are a plane view and a cross sectional view of an active matrix substrate used in a conventional liquid crystal display device of an FFS mode, wherein FIG. 21A is a plane view of the active matrix substrate used in the conventional liquid crystal display device of the FFS mode, and FIG. 21B is a cross sectional view taken along a line A-A′ as indicated in FIG. 21A.

FIG. 22 is a cross sectional view of an active matrix substrate illustrating a conventional state in which a common electrode and a gate bus line upper layer is roughened.

FIG. 23 is a cross sectional view illustrating a conventional state in which a gate insulating film is not capable of covering gate bus lines, caused by the gate bus lines being tapered back (peaked).

FIG. 24 is a plane view of an LCD panel illustrating a conventional position of common electrode wires.

FIG. 25 is a cross sectional view illustrating a conventional active matrix substrate.

FIG. 26 is a cross sectional view illustrating a conventional active matrix substrate.

FIG. 27 is a cross sectional view illustrating a conventional active matrix substrate.

### DESCRIPTION OF THE PREFERRED EMBODIMENTS

Preferred embodiments of the present invention are described below with reference to the attached drawings.

### Arrangement of Active Matrix Substrate

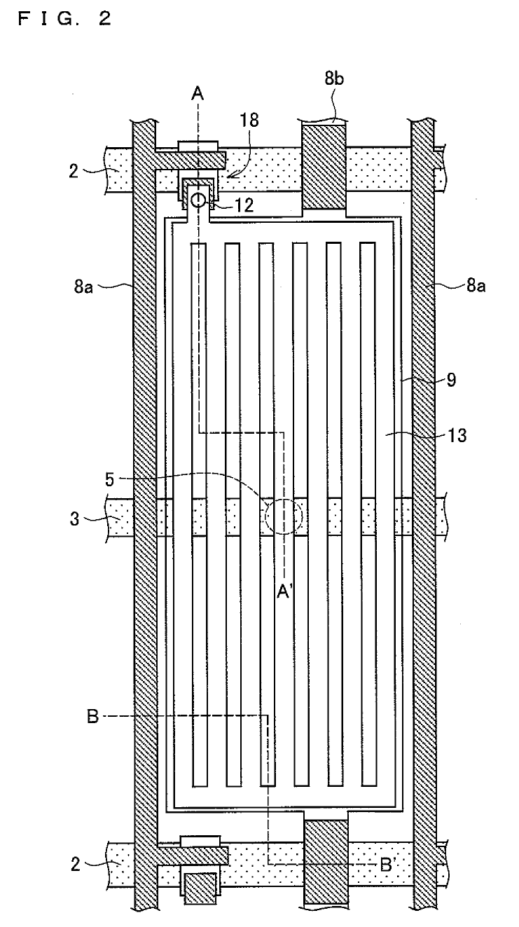

FIG. 2 is a plane view illustrating one pixel area of an active matrix substrate according to a preferred embodiment of the present invention.

An active matrix substrate according to a preferred embodiment of the present invention includes a plurality of source wires 8a and a plurality of gate wires (scanning signal lines) 2, a plurality of preferably rectangular-shaped (straight comb-shaped) pixel electrodes 13, common electrodes 9, common electrode wires 8b, auxiliary electrode wires 3, and TFTs (Thin Film Transistor) 18, as illustrated in FIG. 2. The plurality of source wires 8a and the plurality of gate wires 2 intersect with each other. Each of the plurality of rectangular-shaped pixel electrodes 13 is arranged parallel or substantially parallel to the source wires (video signal lines) 8a in areas (pixel areas; later described) surrounded by the source wires 8a and the gate wires 2. Each of the common electrodes 9 is provided under the pixel electrodes 13. The common electrode wires 8b extend in a parallel or substantially parallel direction relative to the source wires 8a from the common electrodes 9. Each of the auxiliary common electrode wires 3 are arranged parallel or substantially parallel to the gate wires 2 between adjacent gate wires 2. The TFTs 18 serves as a switching element.

In the present specification, an area surrounded by two adjacent source wires 8a and two adjacent gate wires 2 is called a pixel area. Moreover, each of the common electrode wires 3 are provided between respective two adjacent gate wires 2, as illustrated in FIG. 2.

For convenience, in the following description, sources (source electrode) which form the TFTs 18 and gates (gate electrode) which also form the TFTs 18 are given identical reference numerals as the source wires and the gate wires, respectively.

In the present preferred embodiment, the common electrodes 9 are provided in the pixel areas, and the common electrode wires 8b are arranged parallel or substantially parallel to the source wires 8a to connect adjacent ones of the common electrodes 9. Further, the auxiliary common electrode wires 3 that are connected to the common electrodes 9 via contact holes are arranged parallel or substantially parallel to the gate wires 2.

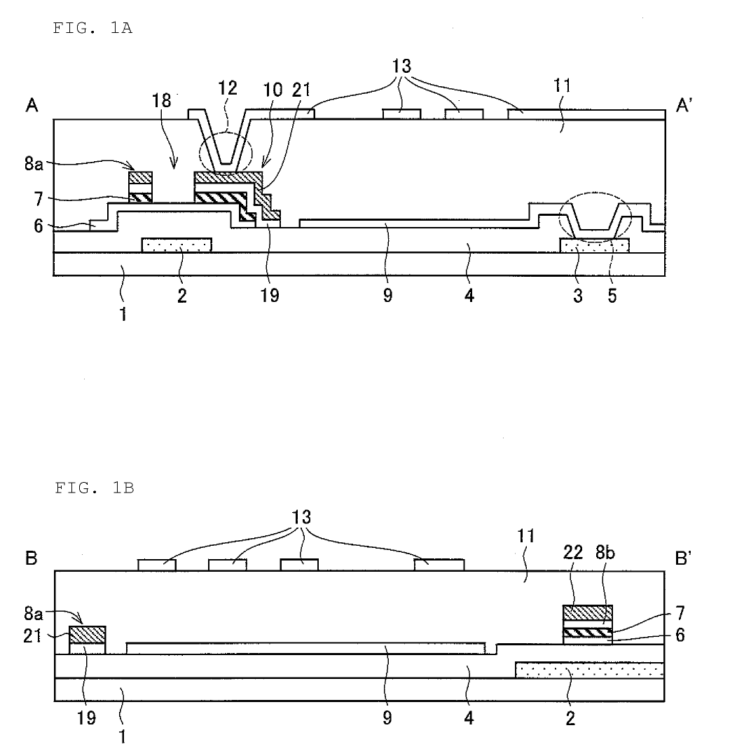

The common electrodes 9 and the auxiliary common electrode wires 3 intersect in the pixel areas, and on the common electrodes 9 at these intersections, contact holes 5 are provided (see FIG. 1A). On the other hand, contact holes 12 are arranged on the pixel electrodes 13 so as to connect the pixel electrodes 13 to respective TFTs 18 (see FIG. 1A). Note that the contact holes 5 are not necessarily provided in all of the pixel areas, and may be provided in pixel areas alternately skipped by one or two pixel areas.

FIG. 1A is a cross sectional view taken along a line A-A′ as indicated in FIG. 2. This cross section taken along the line A-A′ illustrates a cross section from the TFT 18 to the intersecting section of the common electrode 9 and the auxiliary common electrode wires 3.

As illustrated in FIG. 1A, an insulating substrate 1 is provided as the bottom-most layer of the active matrix substrate, and on the insulating substrate 1, the gate 2 and the auxiliary common electrode wires 3 are spaced apart from each other. An a-Si layer 6 and an n⁺-Si layer 7, for example, are provided on the gate 2 in this order, having a gate insulating film 4 sandwiched between the gate 2 and the a-Si layer 6. The a-Si layer 6 and the n⁺-Si layer 7 define a channel section. Further, a source 8a and a drain (drain electrode) 10, each of which construct the TFT 18, are provided on the channel section. In the present preferred embodiment, the source 8a and the drain 10 include a transparent conductive film (ITO) 19 and a metal layer 2 so as to be of a double-layered structure as illustrated in FIG. 1A, which transparent conductive film (ITO) 19 serves as a lower layer and metal layer 21 serves as an upper layer. Further, the metal layer 21 as the upper layer of the drain 10 is connected to the pixel electrodes 13 via the contact hole 12. In addition, an interlayer insulating film 11 is provided on an upper surface of the metal layer 21 on a position other than the contact hole 12.

On the other hand, the gate insulating film 4 and the common electrode 9 are provided on the auxiliary common electrode wires 3 in this order. The auxiliary common electrode wires 3 and the common electrode 9 are connected to each other via the contact hole 5. Particularly, as can be seen in FIG. 1A, a layer arranged on a same layer as the transparent conductive film (ITO; transparent electrode layer) which is the lower layer of the source 8a and the drain 10 serves as the common electrode 9. The pixel electrodes 13 are provided on the common electrode 9 via the interlayer insulating film 11. The interlayer insulating film 11 is composed of an inorganic film, such as SiNx, SiO₂ and the like.

FIG. 1B is a cross sectional view taken along a line B-B′ as indicated in FIG. 2. The cross section taken along the line B-B′ illustrates a cross section from the source wires 8a to the intersecting section of the gate wires 2 and the common electrode wires 8b, passing through the pixel area.

As illustrated in FIG. 1B, the insulating substrate 1, the gate insulating film 4, the source wires 8a, and the interlayer insulating film 11 are provided in an area corresponding to the source wires 8a in this order. The source wires 8a are of a double-layered structure having the transparent conductive film (ITO) 19 as the lower layer and the metal layer 21 as the upper layer. In the pixel area, the insulating substrate 1, the gate insulating film 4, the common electrode 9, the interlayer insulating film 11, and the pixel electrodes 13 are provided in this order. Further, in an area corresponding to the intersecting section of the gate wires 2 and the common electrode wires 8b, the insulating substrate 1, the gate wires 2, the gate insulating film 4, the a-Si layer 6, the n⁺-Si layer 7, the common electrode wires 8b, the metal layer 22, and the interlayer insulating film 11 are provided in this order.

Note that, as shown in FIG. 2 and FIG. 1B, the metal layer 22 is provided on the intersecting section of the common electrode wires 8b and the gate wires 2.

### Method for Manufacturing Active Matrix Substrate

The following description explains a method for manufacturing an active matrix substrate. This method for manufacturing the active matrix substrate preferably uses six masks. However, the auxiliary common electrode wires 3 are not essential in the arrangement. Therefore, in a case where the auxiliary common electrode wires 3 are not provided, a step for forming the contact hole 5 is unnecessary. As a result, the active matrix substrate can be manufactured by use of five masks.

### Step 1

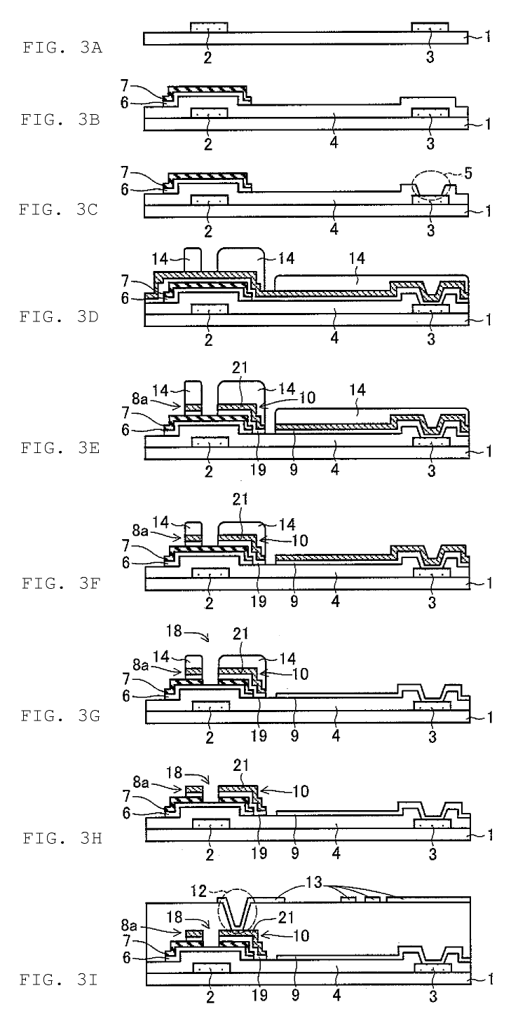

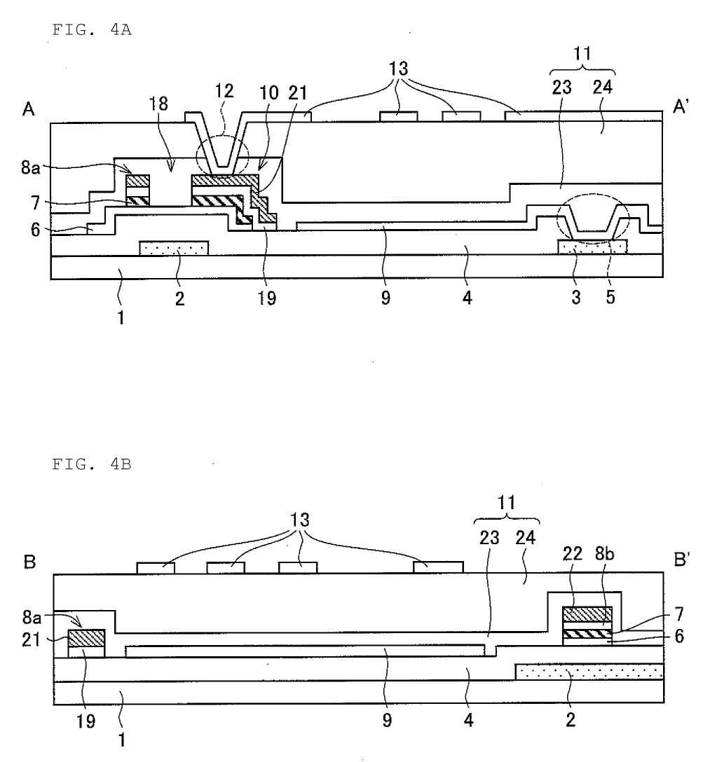

As illustrated in FIG. 3A, a film is formed on the insulating substrate 1 by, for example, sputtering Ti/Al/Ti or the like in a thickness of approximately 250 nm, for example. Thereafter, by, for example, a photolithography method, the gate 2 and the auxiliary common electrode wires 3 are formed spaced apart from each other. In this step 1, a first mask is to be used.

### Step 2

By, for example, a plasma CVD (chemical vapor deposition) method, the gate insulating film (e.g., silicon nitride; SiNx) 4, the a-Si layer 6, and the n+-Si layer 7 are formed consecutively in this order having a thickness of, for example, approximately 300 nm, approximately 150 nm, and approximately 50 nm, respectively. After formation of the films, positions corresponding to the gate 2 and the auxiliary common electrode wires 3 are patterned as an island-shape by the photolithography method, as illustrated in FIG. 3B. Note that a channel section of the TFT 18 is still not formed at this point. In the step 2, a second mask is to be used.

### Step 3

The gate insulating film 4 provided on the auxiliary common electrode wires 3 is etched in a predetermined pattern by the photolithography method as illustrated in FIG. 3C, to form the contact hole 5 and a wires lead-out terminal pad section (not illustrated) of the gate wires 2 and the source wires 8b. In the step 3, a third mask is to be used.

### Step 4

A transparent conductive layer made of ITO is formed as a lower layer having a thickness of, for example, approximately 100 nm, and a metal layer made of Mo/Al/MoN or the like is formed as an upper layer having a thickness of, for example, approximately 150 nm, consecutively, by sputtering, for example. Following formation of the film, a photoresist 14 is formed as illustrated in FIG. 3D. The photoresist 14 causes, by a halftone exposure method, a remaining amount of photoresist on the film in (i) an area in which the transparent conductive film and the metal layer are both to be removed, (ii) a first area (an area forming the source 8a or the drain 10) in which the transparent conductive film and the metal layer are both to remain, and (iii) a second area (an area forming the common electrode 9) in which the transparent conductive film and the metal layer are both to remain, to be approximately 0 nm, approximately 3000 nm, and approximately 1000 nm, respectively. Although not illustrated in the drawings, the photoresist 14 that causes a film to remain by an amount of approximately 3000 nm is also formed on an area on which the common electrode wires 8b are to be formed. In this step, a fourth mask is to be used.

### Step 5

The metal film is etched by a wet etching method by use of a wet etching liquid containing a phosphoric acid-hydrochloric acid-nitric acid type etching liquid. Further, the transparent conductive film is etched by a wet etching method by use of a ferric chloride etchant. This forms the source 8a and the drain 10, as illustrated in FIG. 3E.

The source 8a and the drain 10 are formable as a double-layered structure by carrying out this step, having the transparent conductive film (ITO) 19 as a lower layer and the metal layer 21 as an upper layer. Further, the common electrode 9 is simultaneously formed.

Furthermore, a point that is to be particularly noted in this step and in Step 4 is that, a bottom-most layer of the source 8a and the drain 10 is the transparent conductive film (ITO) 19, and that this bottom-most layer being the transparent conductive film (ITO) 19 also serves as the common electrode 9.

Note that although not illustrated in the drawings, the common electrode wires 8b is also formed in this step.

### Step 6

The photoresist 14 provided on the area on which the common electrode 9 is formed is removed by a dry etching method utilizing a gas containing O₂, as illustrated FIG. 3F.

### Step 7

As illustrated in FIG. 3G, the metal film on the area on which the common electrode 9 is formed is removed by, for example, a wet etching method utilizing the phosphoric acid-hydrochloric acid-nitric acid type etching liquid. Thereafter, a channel section including the a-Si layer 6 and the n⁺-Si layer 7 is formed by the dry etching method utilizing a gas containing SF₆. This forms, for each pixel, a TFT 18 which serves as a switching element.

### Step 8

The photoresist on the area on which the source 8a, the common electrode wires 8b, and the drain 10 are formed is removed by the dry etching method utilizing the gas containing O₂, as illustrated in FIG. 2H.

Note that, although not illustrated in the drawing, the photoresist on the area on which the common electrode wires 8b is formed is simultaneously removed.

### Step 9

A silicon nitride film is formed in a thickness in a range of, for example, approximately 250 nm to approximately 500 nm so as to serve as the interlayer insulating film 11, by the plasma CVD method. This interlayer insulating film 11 is then etched in a predetermined pattern by the photolithography method so as to form the contact hole 12 and the wires lead-out terminal pad section (not illustrated) of the gate wires 2 and source wires 8a. Following this, the transparent conductive film made of ITO is formed by sputtering in a thickness of, for example, approximately 100 nm on the interlayer insulating film 11. Thereafter, the pixel electrodes 13 are etched in a predetermined pattern (by use of a sixth mask). This concludes the formation of the active matrix substrate illustrated in FIG. 1A.

As described above, the active matrix substrate of a preferred embodiment of the present invention has a wiring structure in which the source/drain electrodes have transparent electrodes as the bottom-most layer, and further has the transparent electrodes that are the bottom-most layer to serve as a common electrode, as illustrated in FIG. 1A. In the present preferred embodiment, the common electrodes are provided on the bottom-most layer of the source electrodes/wires and the drain electrodes/wires, and not the ITO (common electrode) serving as a bottom-most layer of the gate electrodes/wires. Conventionally, the ITO is arranged parallel or substantially parallel to the gate electrode/wires.

In comparison, the present preferred embodiment forms the source electrodes/wires 8a and the drain electrodes/wires 10 by use of a transparent conductive film (ITO) 19 and an opaque metal layer 21 provided on the ITO 19 as an upper layer of the ITO 19. This enables leading out of the common electrode wires 8b formed by the ITO 19 parallel to the source wires.

If the ITO is provided on the bottom-most layer of the gate electrodes/wires as with a conventional active matrix substrate, a problem occurs that the gate electrodes/wires roughens since an amorphous silicon on a gate insulating film is positioned on an upper side of the ITO. If the gate electrodes/wires roughen, the flatness decreases and the roughness of the TFT channel section increases. This causes a decrease in mobility. In comparison, the present preferred embodiment does not provide the ITO on the bottom-most layer of the gate electrodes/wires. Thus, it is possible to avoid the problem of the amorphous silicon being roughened.

Further, the ITO has an extremely low transition temperature of crystallization in a case where the ITO is provided on the bottom-most layer of the gate electrodes/wires as with the conventional active matrix substrate. That is to say, the ITO polysiliconizes from an amorphous state at around a temperature in a range of, for example, approximately 150° C. to approximately 200° C. When the transparent electrodes are compared between a crystallized state and the amorphous state, a large difference is recognized in an etching rate. Therefore, polysiliconization of the transparent electrodes cause a need to etch for a remarkably long period of time. In other words, over-etching must be carried out. As a result, the gate wires become tapered back (peaked), which causes a problem that the gate insulting film cannot be covered. On the other hand, with the present preferred embodiment, the ITO is not provided on the bottom-most layer of the gate electrodes/wires. As a result, it is possible to avoid such problems.

As described above, the ITO is provided as the bottom-most layer of the source electrodes/wires and the drain electrodes/wires. Further, it is arranged such that the common electrode wires provided by the ITO are lead out parallel or substantially parallel to the source wires. Generally, the source wires are shorter than the gate wires. For example, in a case of an XGA standard, a number of wires is 768×1024 (D×W). Therefore, an aspect ratio of the display section is 3:4. Further, in a case of a full HD standard that is adopted in large-screen televisions, the number of wires is 1080×1920 (D×W), and the aspect ratio of the display screen is 9:16.

As a result, signal delay caused by resistance is reduced in wires that are parallel or substantially parallel to the source wires, as compared to wires that are parallel to the gate wires.

Further, the present preferred embodiment has the auxiliary common electrode wires 3 provided parallel or substantially parallel to the gate electrode/wires 2 between adjacent gate electrode/wires 2, in addition to the common electrode wires 8b provided parallel or substantially parallel to the source wires/electrode 8a. That is to say, common electrode wires are reticulately provided, by connection of the wires. Thus, this makes it possible to have an arrangement in which resistance is determined just by relation of the aspect ratio, regardless of a size of a display section. As a result, the resistance between two arbitrary points is reduced. In addition, reticulately providing the common electrode wires achieves redundancy in four directions.

As illustrated in FIG. 1B, the metal layer 22 is provided as an upper layer of the common electrode 8b in an area corresponding to the intersecting section of the gate electrodes/wires 2 and the common electrode wires 8b. The intersecting section has narrow common electrode wires 8b. Therefore, breaking of the wires may readily occur, and a loss due to resistance is great. In comparison, as described above, the common electrode wires 8b having the metal layer 22 as the upper layer of the common electrode wires 8b secures connection at the metal layer even if breaking of the wires occur under the metal layer. In addition, the loss due to the resistance is suppressed by having a low resistant metal layer 22 stacked on the common electrode wires 8b.

Further, as illustrated in FIG. 1B, in the area corresponding to the intersecting section of the gate electrodes/wires 2 and the common electrode wires 8b, a semiconductor layer including the a-Si layer 6 and the n⁺-Si layer 7 is provided. Therefore, it is possible to (i) have a reasonable distance between the gate electrodes/wires 2 and the common electrode wires 8b and (ii) reduce a capacitance between the gate electrodes/wires 2 and the common electrode wires 8b, as compared to an arrangement that does not provide the semiconductor layer.

The common electrode wires 3 are provided between two respective adjacent gate electrodes/wires 2, as illustrated in FIG. 2. This provides a reasonable distance between the common electrode wires 3 and the gate electrodes/wires 2. Consequently, it is possible to reduce the possibility of a short between the common electrode wires 3 and the gate electrodes/wires 2 caused by poor patterning and adhering of dust.

The following description explains other preferred embodiments that are modifications of the preferred embodiment shown in FIG. 2. In the modifications explained below, explanations of common points with the foregoing embodiment are omitted, and identical reference numerals are used. For convenience, the foregoing preferred embodiment is denoted as a preferred embodiment.

### First Preferred Embodiment

FIGS. 4A and 4B illustrate a first preferred embodiment, wherein FIG. 4A is a cross sectional view taken along a line A-A′ corresponding to FIG. 1A, and FIG. 4B is a cross sectional view taken along a line B-B′ corresponding to FIG. 1B. A plane view of the first preferred embodiment is identical to FIG. 2. Therefore, the plane view of the first preferred embodiment is omitted here.

The preferred embodiment has a single-layered interlayer insulating film 11 as illustrated in FIGS. 1A and 1B. In comparison, the first preferred embodiment has a double-layered interlayer insulating film 11, as illustrated in FIGS. 4A and 4B. More specifically, in the first preferred embodiment, the interlayer insulating film 11 is so arranged as a double-layered structure including an inorganic film 23 made of SiNx, SiO₂ or the like, and a film 24 made of low-dielectric constant organic material.

This allows for reduction of parasitic capacitance as compared to the preferred embodiment. Further, defects such as leakage are reduced as compared to the preferred embodiment. Therefore, a high reliability is realizable.

The following is an explanation of a reason why the defect such as leakage is reduced in the first preferred embodiment. In an arrangement in which two layers of metal layers sandwich a single-layered insulating film, a pinhole or a defect in the single-layered insulting film causes a leakage in the upper and the lower metal layers. Further, with this arrangement, if an etchant (etching liquid) that is used for wet etching the upper metal layer can also etch the lower metal layer, the lower metal layer is etched in a case where the single-layered insulating film has the pinhole or defect. This causes breaking of wires and the like. Usually, no matter how a dust management is carried out, the insulating film has some pinhole or defect.

In response to this, a possibility of the pinhole or defect occurring at a same position in the two layers of insulating films is dramatically low as compared to a possibility of the pinhole or defect occurring to the single-layered insulating film. Therefore, it is possible to dramatically reduce the possibility of an occurrence of leakage in the upper and lower metal layers and the possibility of breakage in the lower metal layer, by having the insulating film that is sandwiched between the two metal layers have a double-layered structure, as in the arrangement of the first preferred embodiment.

Note that the first preferred embodiment is manufactured by forming, in Step 9, as the interlayer insulating film, an inorganic film made of SiNx, SiO₂ or the like in a thickness in a range of, for example, about 150 nm to about 350 nm, and then forming a film made of low dielectric constant organic material in a thickness in a range of, for example, about 2000 nm to about 4000 nm on the inorganic film.

The explanation of the first preferred embodiment describes an interlayer insulating film of a double-layered structure, however the structure of the interlayer insulating film is not limited to two layers, and may have three or more layers, by arbitrarily stacking the inorganic film 23 made of the SiNx, SiO₂ or the like and the film 24 made of low dielectric constant organic material.

### Second Preferred Embodiment

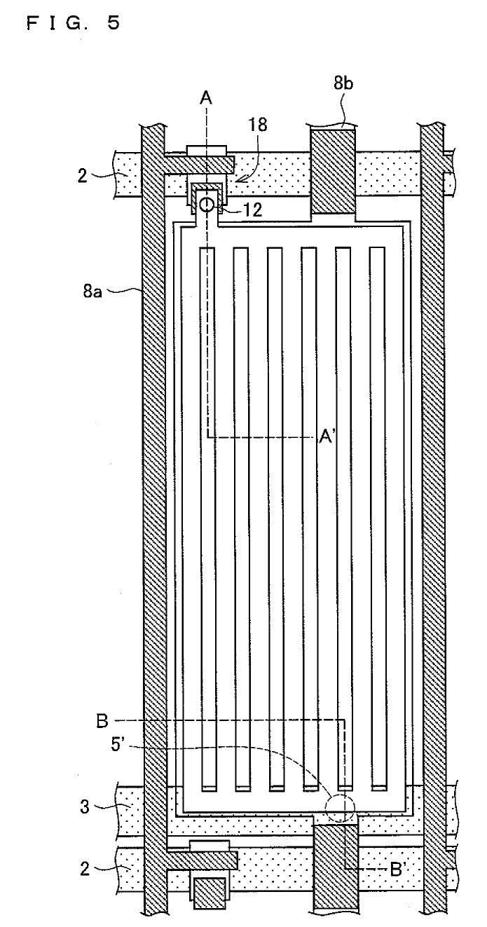

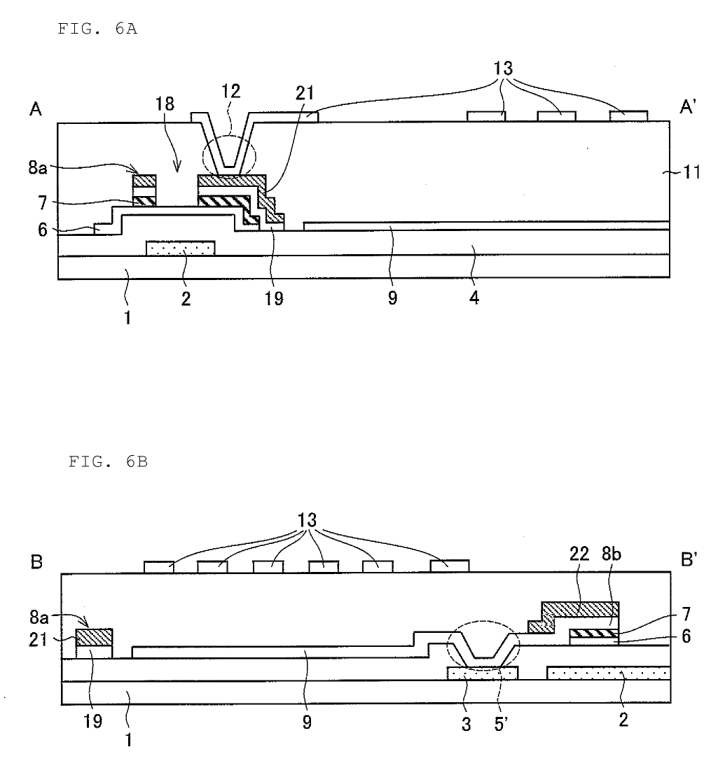

FIG. 5 illustrates a second preferred embodiment, and is a plane view corresponding to FIG. 2. In addition, FIG. 6A is a cross sectional view taken along a line A-A′ as indicated in FIG. 5, and FIG. 6B is a cross sectional view taken along a line B-B′ as indicated in FIG. 5.

In the preferred embodiment shown in FIG. 2, the auxiliary common electrode wires 3 are arranged substantially at a midpoint between adjacent gate wires 2, respectively. In comparison, the second preferred embodiment arranges the auxiliary common electrode wires 3 in a vicinity of one of the respective adjacent gate wires 2. More specifically, the auxiliary common electrode wires 3 has a section that does not overlap with the pixel electrodes 13 in an extending direction of the source wires 8a. That is to say, the auxiliary common electrode wires 3 juts out from the pixel electrodes 13 in the extending direction of the source wires 8a. Moreover, the second preferred embodiment has a contact hole 5′ at least on a portion of the common electrode wires 8b.

The arrangement illustrated in the cross section taken along the line A-A′ as indicated in FIG. 6A, that is, the cross section including an area in which the TFT 18 is provided to around a center of the pixel area, does not include the auxiliary common electrode wires 3, as different to FIG. 2A. On the other hand, the arrangement illustrated in the cross section taken along the line B-B′ as indicated in FIG. 6B, that is, the cross section including the area corresponding to the gate wires 2 to the area corresponding to the intersecting section of the gate wires 2 and the common electrode wires 8b via the pixel area includes the auxiliary common electrode wires 3 provided in the pixel area, which is different from what is shown in FIG. 2B. The auxiliary common electrode wires 3 and the common electrodes 9 (including portions of the common electrode wires 8b) are connected via the contact hole 5′ formed on a position in which a portion overlaps with the area of the common electrode wires 8b.

This allows for partial arrangement of the auxiliary electrode wires 3 on a section which does not contribute to an aperture. That is, it is possible to reduce a disabled area (area in which liquid crystal does not move, and a liquid crystal domain area). Therefore, a high aperture ratio is realized.

The following description specifically explains a reason why this high aperture ratio is realized. First, the disabled area is defined. The disabled area denotes areas of the following (A) through (D).

(A) A portion in which the auxiliary common electrode wires 3 are provided.

(B) At least both edges (portions of which the comb-shaped teeth of the pixel electrodes are bundled and connected) of the pixel electrodes 13 that are parallel or substantially parallel to the source wires 8a, among portions of the common electrodes 9 and the pixel electrodes 13 which overlap with each other.

(C) Other gaps between the gate electrodes/wires 2 and the auxiliary common electrode wires 3, and gaps between the source wires 8a and the common electrode 9 (although dependent on a design rule).

(D) A disabled area generated due to an oriented state of the liquid crystal.

In the preferred embodiment shown in FIG. 2, the disabled area is (A)+(B)+(C)+(D). On the other hand, in the second preferred embodiment, a portion of the areas (B) and (C) overlap with the area (A), therefore the disabled area is the area excluding the overlapping portions of the disabled areas (B) and (C) with area (A). As a result, the disabled area is reduced in the second preferred embodiment as compared to the preferred embodiment shown in FIG. 2. This allows for realization of the high aperture ratio.

The second preferred embodiment is manufactured by changing, in Step 1, a provided position of the auxiliary common electrode wires 3 to a position closer to the gates 2.

Note that the positioning of the auxiliary common electrode wires 3 in the preferred embodiment shown in FIG. 2 is simply one example, and may be in any position as long as the auxiliary common electrode wires 3 are positioned between two adjacent gate wires 2.

### Third Preferred Embodiment

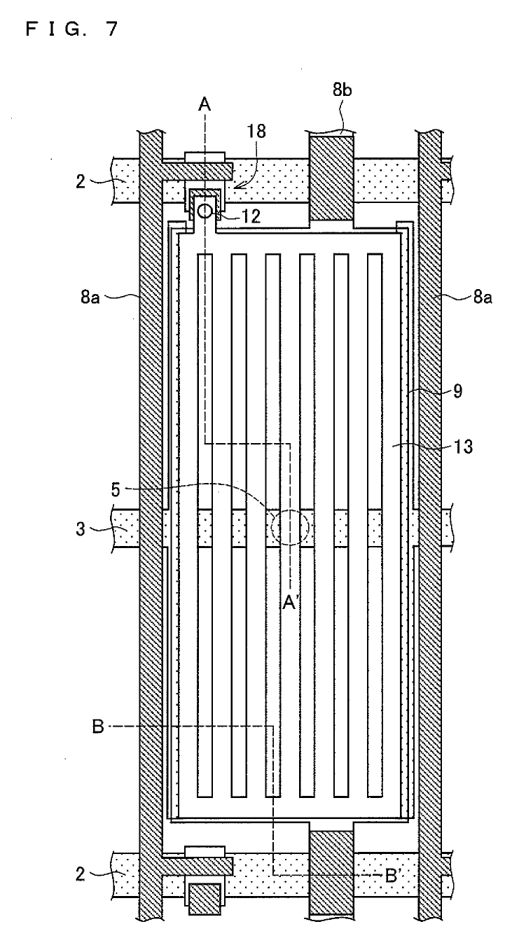

FIG. 7 illustrates a third preferred embodiment, and is a plane view corresponding to FIG. 2. In addition, FIG. 8A is a cross sectional view taken along a line A-A′ as indicated in FIG. 7, FIG. 8B is a cross sectional view taken along a line B-B′ as indicated in FIG. 7.

The third preferred embodiment, in addition to the arrangement of the preferred embodiment shown in FIG. 2, has the auxiliary common electrode wires 3 extend to an outer peripheral section (disabled area) of the pixel area, and extend in the outer peripheral section so as to be parallel or substantially parallel to the source wires 8a, as illustrated in FIG. 7. In other words, the auxiliary common electrode wires 3 are extended to a surrounding section (outer peripheral section) of the common electrodes 9, and extended in the surrounding section so as to be parallel or substantially parallel to the source wires 8a. Namely, as illustrated in FIG. 7, a shape of the auxiliary common electrode wires 3 from a plane view is in an H-shape.

The cross section of FIG. 8A taken along the line A-A′ does not pass through characteristic elements of the third preferred embodiment, therefore is identical to FIG. 1A. As illustrated in FIG. 8B of the cross section taken along the line B-B′, the auxiliary common electrode wires 3 is provided on the insulating substrate 1 in the disabled area (area in which liquid crystal does not move, and liquid crystal domain occurrence area) on the source wires 8a side of the pixel areas. Therefore, light shielding of the disabled area is possible without the need to add any processes to the preferred embodiment shown in FIG. 2. This allows for attainment of a high display quality. The third preferred embodiment is manufactured by forming, in Step 1, the auxiliary common electrode wires 3 parallel or substantially parallel to the source wires 8a in the disabled area on the source wires 8a side of the pixel areas.

Further, the auxiliary common electrode wires 3 may be arranged so as to extend to the outer peripheral section of the pixel area, and extend in the outer peripheral section so as to be parallel or substantially parallel to the source wires 8a, and also extend in the outer peripheral section so as to be parallel or substantially parallel to the gate wires 2, so as to surround the entire outer peripheral section of the pixel areas. That is to say, the common electrode wires 3 may be arranged in a ring shape configuration.

### Fourth Preferred Embodiment

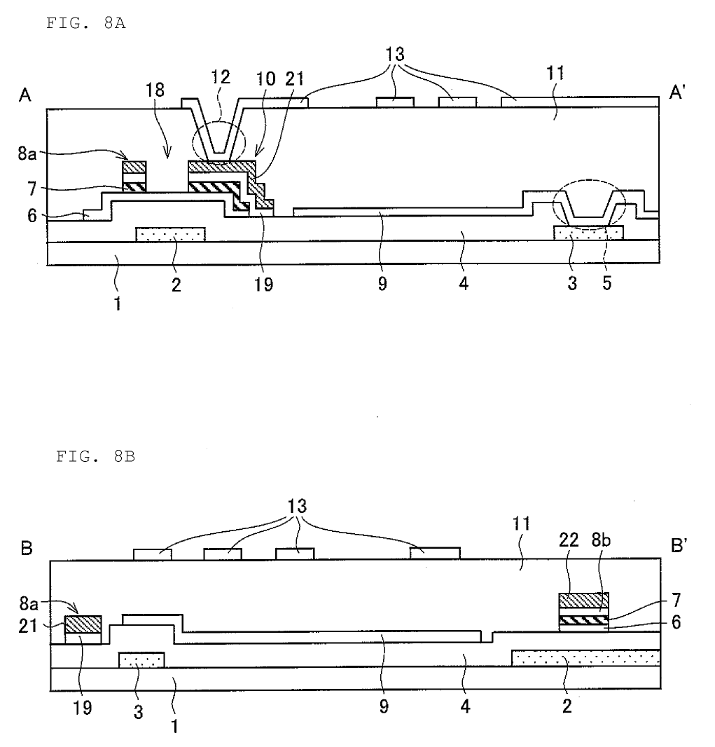

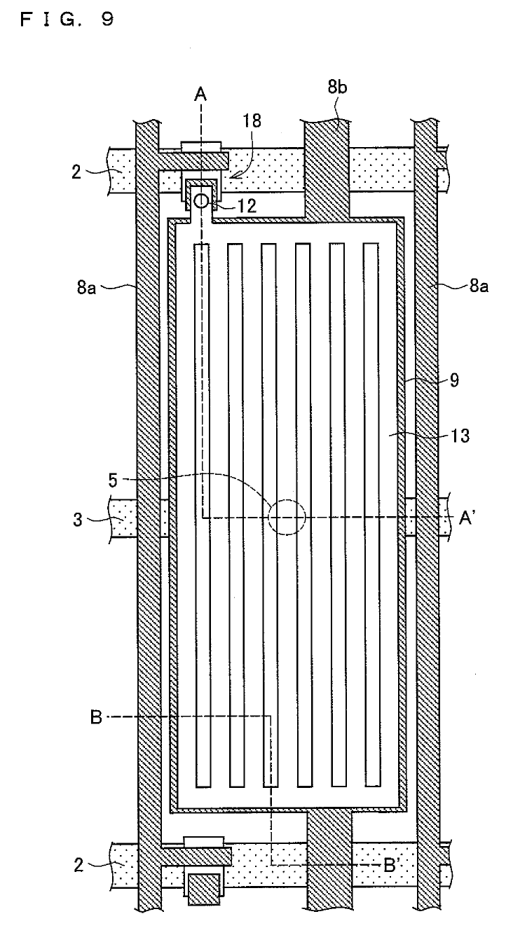

FIG. 9 illustrates a fourth preferred embodiment, and is a plane view corresponding to FIG. 2. In addition, FIG. 10A is a cross sectional view taken along a line A-A′ as indicated in FIG. 9, and FIG. 10B is a cross sectional view taken along a line B-B′ as indicated in FIG. 9.

In the fourth preferred embodiment, a same metal layer as the metal layer 21 which is provided as the upper layer of the source 8a and the drain 10 is provided as a light shielding film (metal layer arranged to surround outer peripheries of the common electrodes) 25 to shield a liquid crystal domain, at a surrounding section (outer peripheral section) of the common electrodes 9, as illustrated in FIG. 9, FIG. 10A, and FIG. 10B. The light shielding film 25 may be arranged so as to cover the entire common electrode wires 8b, as illustrated in FIG. 9. The metal layer used for the light shielding film 25 is not limited to ones that have a function of a light shielding film. Namely, the light shielding function is simply one example.

The light shielding film 25 is preferably formed by not removing all of a metal film corresponding to a position on which the common electrodes 9 are to be formed but have the metal film remain on the surrounding section of the common electrodes 9, when removing the metal film in Step 7.

The arrangement allows the areas surrounding of the common electrodes 9 to have a light shielding function, and allows for reduction of a resistance of the common electrodes 9 and the auxiliary common electrode wires 3, by providing the light shielding film 25 that is made of a low resistance metal layer.

### Fifth Preferred Embodiment

FIG. 11 illustrates a fifth preferred embodiment, and is a plane view corresponding to FIG. 2. FIG. 12 is a cross sectional view taken along a line A-A′ as indicated in FIG. 11. FIG. 13 is an enlarged view of section C illustrated in FIG. 11, that is, an intersecting section of the common electrode 9 and the common electrode wires 3. FIG. 14 is a cross sectional view taken along a line B-B′ as indicated in FIG. 13. As illustrated in FIG. 11, the pixel electrodes 13 illustrated in the fifth preferred embodiment are cut off at a portion in which the common electrodes 9 and the auxiliary common electrode wires 3 intersect with each other. At this intersecting section, contact electrode pads 17 are arranged to be separated from the pixel electrodes 13. The contact electrode pads 17 electrically connect the common electrodes 9 and the auxiliary common electrode wires 3.

Reference numeral 16 in FIG. 13 illustrates an opening of the common electrodes 9. That is to say, in the fifth preferred embodiment, an opening is provided at the intersecting section of the common electrodes 9 and the auxiliary common electrode wires 3, as illustrated in FIGS. 12 and 14. Further, as shown in FIGS. 12 and 14, the interlayer insulating film 11 and the gate insulating film 4 are hollowed out at a position in which the contact electrode pad 17 is provided.

In the preferred embodiment shown in FIG. 2, the common electrodes 9 and the auxiliary electrode wires 3 are electrically connected to each other via the contact holes 5 provided on the gate insulating film 4. In comparison, the fifth preferred embodiment provides the contact electrode pads 17 that are connected to both the common electrodes 9 and the auxiliary common electrode wires 3, as illustrated in FIGS. 12 and 14. Namely, the common electrodes 9 and the auxiliary common electrode wires 3 are connected to each other via the contact electrode pads 17.

The contact electrode pads 17 are formed along the interlayer insulating film 11, and one end is connected to the common electrodes 9, and the other end is connected to the auxiliary common electrode wires 3. This enables electrical connection between the auxiliary common electrode wires 3 and the common electrodes 9 as indicated by the broken arrow in FIG. 14. The contact electrode pad 17 can be simultaneously formed during the formation of the pixel electrodes 13. Note that, although the contact electrode pads 17 connect the common electrodes 9 and the auxiliary common electrode wires 3 in the extending direction of the source wires 8a, this is simply one example, and the common electrodes 9 and the auxiliary common electrode wires 3 may be connected in an extending direction of the gate wires 2, for example.

A reason why the opening 16 of the common electrodes 9 and the contact electrode pads 17 are arranged as illustrated in FIGS. 12 and 14 is later described with reference to drawings.

In the preferred embodiment shown in FIG. 2, six mask processes are required for manufacturing the active matrix substrate. In comparison, the fifth preferred embodiment can manufacture the active matrix substrate in a five-mask process. A reason for this is because the contact holes 5 can be formed simultaneously with a photopatterning of the interlayer insulating film 11. This enables elimination of a photo step for forming the contact holes 5.

The following description explains a method for manufacturing the active matrix substrate illustrated in FIG. 12.

### Step 1

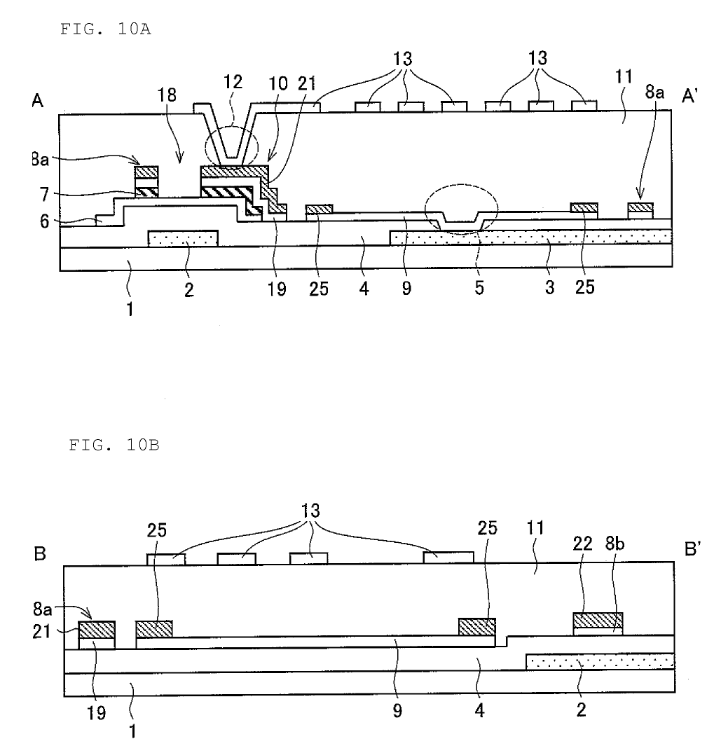

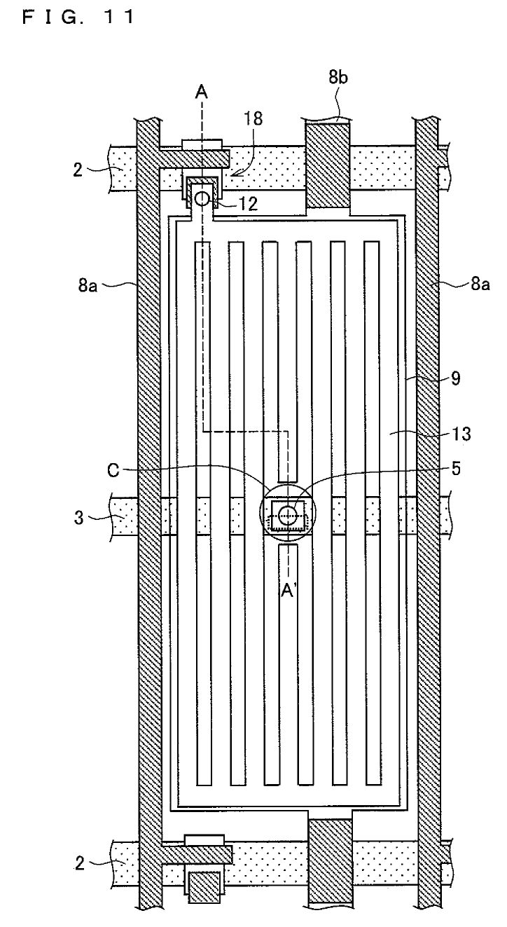

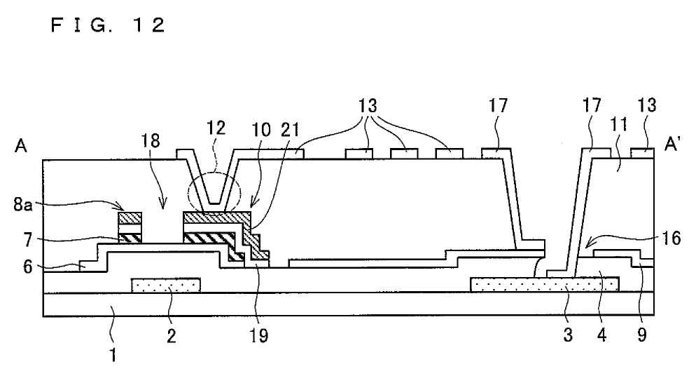

As illustrated in FIG. 15A, a film is formed on the insulating substrate 1 by sputtering Ti/Al/Ti or the like in a thickness of approximately 250 nm, for example. Thereafter, by a photolithography method, the gates 2 and the auxiliary common electrode wires 3 are formed spaced apart from each other. In this step 1, a first mask is to be used.

### Step 2

By a plasma CVD (chemical vapor deposition) method, the gate insulating film (silicon nitride; SiNx) 4, the a-Si layer 6, and the n+-Si layer 7 are formed consecutively in this order having a thickness of, for example, approximately 300 nm, approximately 150 nm, and approximately 50 nm, respectively. After formation of the films, positions corresponding to the gates 2 and the auxiliary common electrode wires 3 are patterned as an island-shape by the photolithography method, as illustrated in FIG. 15B. Note that a channel section of the TFTs 18 is still not formed at this point. In the step 2, a second mask is to be used.

### Step 3

A transparent conductive layer made of ITO is formed as a lower layer having a thickness of approximately 100 nm, and a metal layer made of Mo/Al/MoN or the like is formed as an upper layer having a thickness of approximately 150 nm, consecutively, by sputtering. Following formation of the film, a photoresist 14 is formed as illustrated in FIG. 15C. The photoresist 14 causes, by a halftone exposure method, a remaining amount of photoresist on the film in (i) an area in which the transparent conductive film and the metal layer are both to be removed, (ii) a first area (an area forming the sources 8a or the drains 10) in which the transparent conductive film and the metal layer are both to remain, and (iii) a second area (an area forming the common electrodes 9) in which the transparent conductive film and the metal layer are both to remain, to be approximately 0 nm, approximately 3000 nm, and approximately 1000 nm, respectively. Although not illustrated in the drawings, the photoresist 14 that causes a film to remain by an amount of approximately 3000 nm is also formed on an area on which the common electrode wires 8b are to be formed. In this step, a third mask is to be used.

### Step 4

The metal film is etched by a wet etching method by use of a wet etching liquid containing a phosphoric acid-hydrochloric acid-nitric acid type etching liquid. Further, the transparent conductive film is etched by a wet etching method by use of a ferric chloride etchant. This forms the sources 8a and the drains 10, as illustrated in FIG. 15D.

The sources 8a and the drains 10 are formable as a double-layered structure by carrying out this step, having the transparent conductive film (ITO) 19 as a lower layer and the metal layer 21 as an upper layer. Further, the common electrodes 9 are simultaneously formed.

Note that although not illustrated in the drawings, the common electrode wires 8b are also formed in this step.

### Step 5

The photoresist 14 provided on the area on which the common electrodes 9 are formed is removed by a dry etching method utilizing a gas containing O₂, as illustrated in FIG. 15E.

### Step 6

As illustrated in FIG. 15F, the metal film on the area on which the common electrodes 9 are formed is removed by the wet etching method utilizing the phosphoric acid-hydrochloric acid-nitric acid type etching liquid. Thereafter, channel sections including the a-Si layer 6 and the n⁺-Si layer 7 are formed by the dry etching method utilizing a gas containing SF₆. This forms, for each pixel, TFTs 18 which serve as a switching element.

### Step 7

The photoresist on the area on which the sources 8a, the common electrode wires 8b, and the drains 10 are formed is removed by the dry etching method utilizing the gas containing O₂, as illustrated in FIG. 15G. Note that, although not illustrated in the drawing, the photoresist on the area on which the common electrode wires 8b are formed is simultaneously removed.

### Step 8

A silicon nitride film is formed in a thickness in a range of, for example, approximately 150 nm to approximately 650 nm so as to serve as the interlayer insulating film 11, by the plasma CVD method, as illustrated in FIG. 15H. This interlayer insulating film 11 is then etched in a predetermined pattern by the photolithography method so as to form the contact holes 5 and 12, and the wires lead-out terminal pad section (not illustrated) of the gate wires 2 and source wires 8a. Simultaneously, dry etching of the gate insulating film 4 is carried out by use of the interlayer insulating film 11 as a mask, so that the contact holes 5 are hollowed to reach the auxiliary common electrode wires 3.

Note that a fourth mask is to be used in this step.

### Step 9

The transparent conductive film made of ITO is formed by sputtering in a thickness of approximately 100 nm on the interlayer insulating film 11, as illustrated in FIG. 15I. Thereafter, the pixel electrodes 13, and the contact electrode pads 17 that electrically connect the common electrodes 9 and the auxiliary common electrode wires 3, are etched in a predetermined pattern by the photolithography method. This concludes the formation of the active matrix substrate as illustrated in FIG. 12. In this step, a fifth mask is to be used.

As described above, the fifth preferred embodiment can manufacture the active matrix substrate by use of five masks.

Next is an explanation of each of the cases of using five masks and six masks, with reference to drawings.

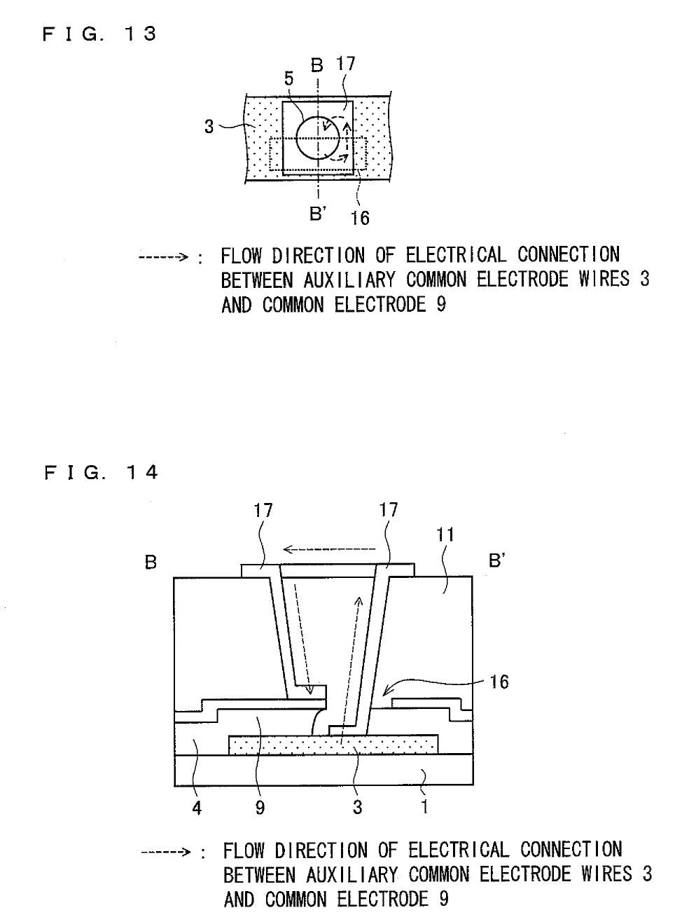

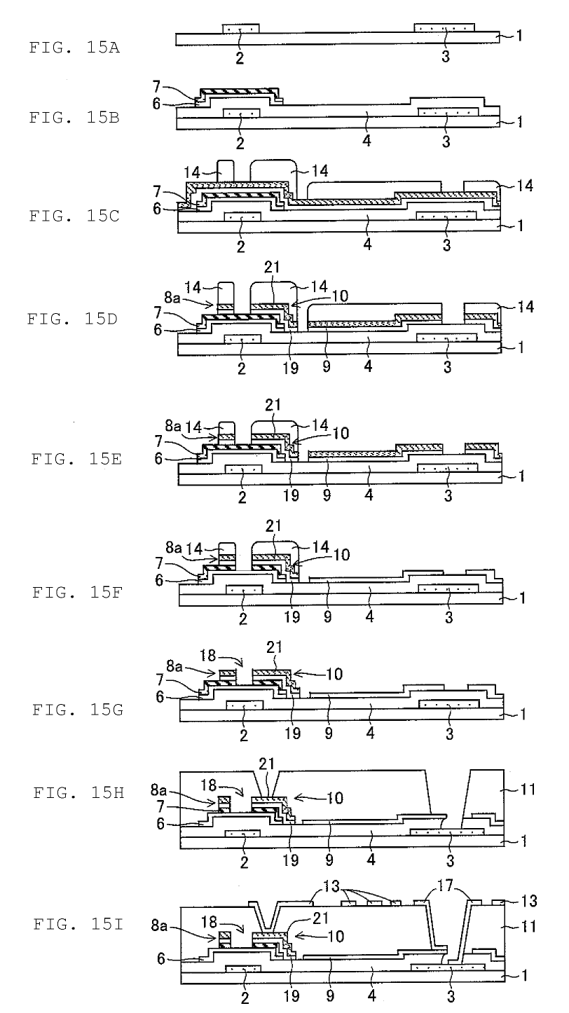

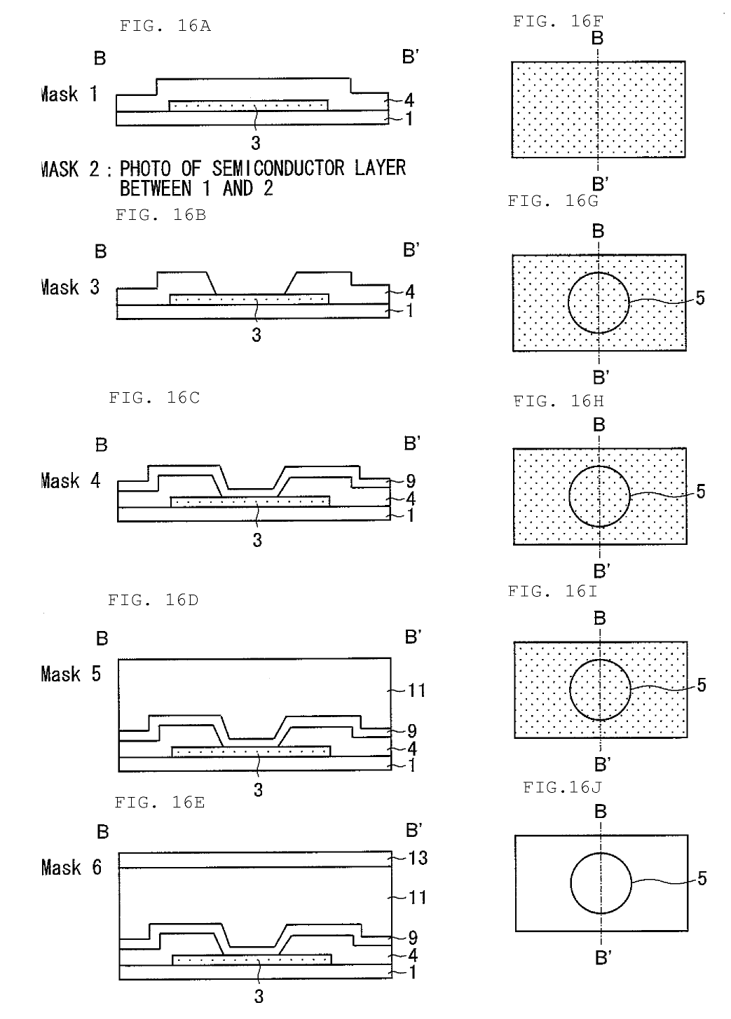

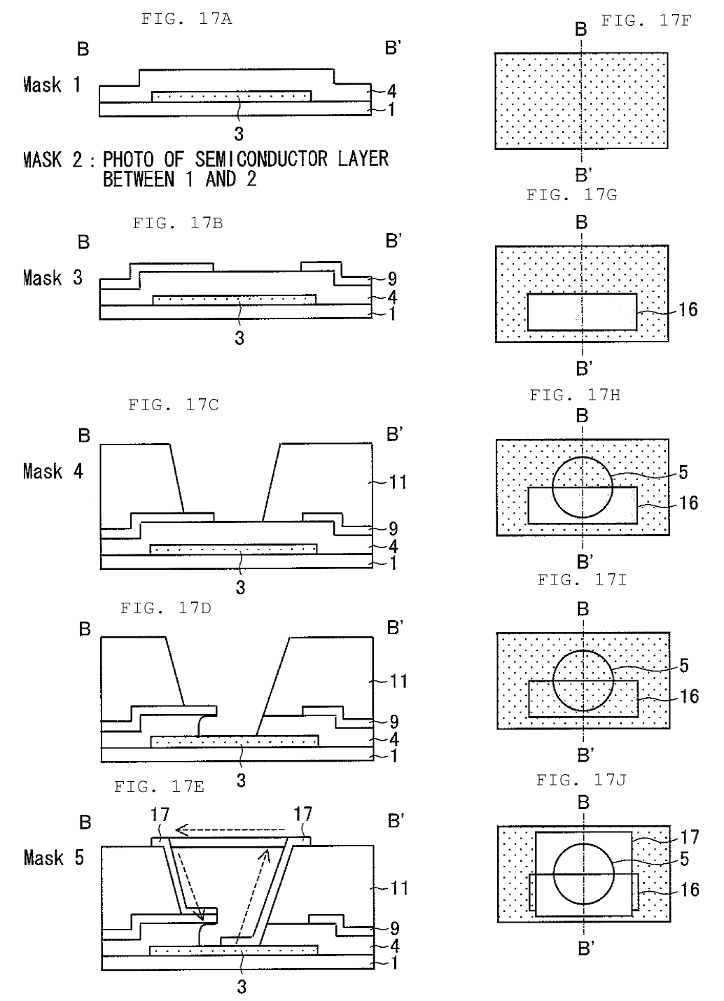

In FIGS. 16A-16J, FIGS. 16A-16E are cross sectional views illustrating a manufacturing process of the contact hole 5 portion of the active matrix substrate in a case where six masks are used, and FIGS. 16F-16J are schematic views illustrating plane views of FIGS. 16A-16E, respectively.

A first mask is used so as to form the auxiliary common electrode wires 3, as illustrated in FIG. 16A. A second mask is used in a photolithography method of a semiconductor layer (not illustrated) A third mask is used so as to form the contact holes 5, as illustrated in FIG. 16B. A fourth mask is used so as to form the common electrodes 9, as illustrated in FIG. 16C. A fifth mask is used so as to pattern the interlayer insulating film 11, as illustrated in FIG. 16D. A sixth mask is used so as to form the pixel electrodes 13, as illustrated in FIG. 16E.

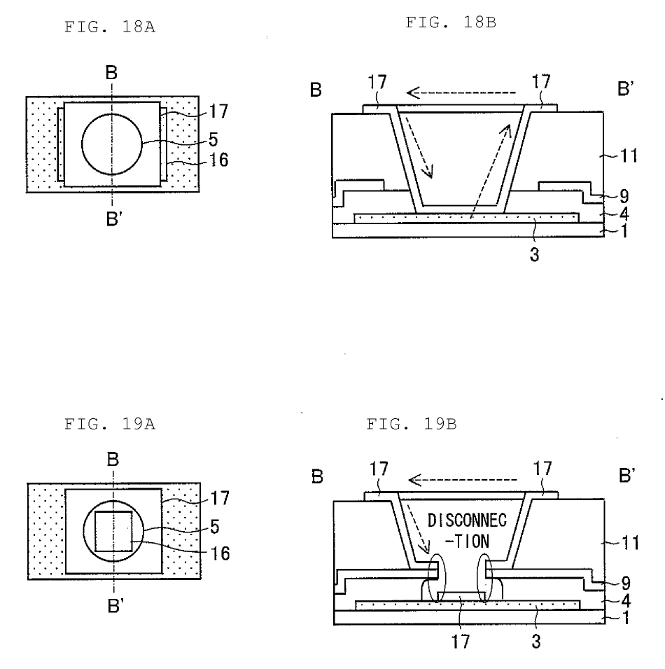

On the other hand, FIGS. 17A-17E are cross sectional views illustrating a manufacturing process of the contact hole 5 portion of the active matrix substrate in a case where five masks are used, and FIGS. 17F-17J are schematic views illustrating plane views of FIGS. 17A-17E, respectively.

A first mask is used so as to form the auxiliary common electrode wires 3 as illustrated in FIG. 17A. A second mask is used in a photolithography method of a semiconductor layer (not illustrated) A third mask is used so as to form openings 16 of the common electrodes 9, as illustrated in FIG. 17B. A fourth mask is used so as to form the interlayer insulating film 11 as illustrated in FIG. 17C. Formation of the contact holes 5 that extend to the auxiliary common electrode wires 3 are carried out by dry etching the gate insulating film 2 by use of the interlayer insulating film 11 as a mask. Therefore, a new mask is not necessary in FIG. 17D. A fifth mask is used so as to form (i) the pixel electrodes 13 and (ii) the contact electrode pads 17 that electrically connect the common electrodes with the auxiliary common electrode wires 3, as illustrated in FIG. 17E. The arrow illustrated in broken lines in FIG. 17D indicates a flowing direction of an electrical connection between the auxiliary common electrode wires 3 and the common electrodes 9.

The following description explains a reason why irregular contact holes 5 are provided in the fifth preferred embodiment, as illustrated in FIG. 12. Two comparative examples of the fifth preferred embodiment are explained each with reference to drawings, in order to explain this reason.

A comparative example is illustrated in FIGS. 18A and 18B, whose openings 16 of common electrodes 9 are larger than openings of contact holes 5. FIG. 18A is a plane view, and FIG. 18B is a cross sectional view taken along a line B-B′ as indicated in FIG. 18A.

In the case of the comparative example, the contact electrode pads 17 are electrically connected to the auxiliary common electrode wires 3, however, they cannot be electrically connected to the common electrodes 9. The reason for this is clear, and therefore it is omitted.

Similarly, another comparative example is illustrated in FIGS. 19A and 19B, whose openings 16 of common electrodes 9 are smaller that of openings of contact holes. FIG. 19A is a plane view, and FIG. 19B is a cross sectional view taken along a line B-B′ as indicated in FIG. 19A.

In this comparative example, the contact electrode pads 17 are electrically connected to the common electrodes 9, however, they cannot be electrically connected to the auxiliary common electrode wires 3. The reason for this is because, since the common electrodes 9 are made of material such as ITO, the common electrodes 9 cannot be dry etched when the contact holes 5 are hollowed to the auxiliary common electrode wires 3 by dry etching the gate insulating film 4 by use of the interlayer insulating film 11 as a mask. As a result, the gate insulating film 4 becomes tapered back, in other words, peaked, which causes the contact electrode pads 17 to be disconnected.

In view of these comparative examples, the active matrix substrate in the fifth preferred embodiment is arranged such that the contact electrode pads 17 are electrically connectable to both the common electrodes 9 and the auxiliary common electrode wires 3. That is to say, the fifth preferred embodiment is so arranged that both arrangements of the two comparative examples are taken into account. Furthermore, in other words, the contact electrode pads 17 are connected to (i) the auxiliary common electrode wires 3 on a first end sections side of the common electrodes 9 located outside of an outer edge of the respective one of the contact holes 5, and (ii) the common electrodes on a second end sections side of the common electrodes 9 located inside of the outer edge of the respective one of the contact holes 5.

The regular six mask process requires, before the formation of the sources and the drains, the adding of a photo step to form the contact holes 5 that electrically connect the common electrodes 9 with the auxiliary common electrode wires 3. In a five mask process, the photo step for forming the contact holes 5 is not carried out before the formation of the sources and the drains. Instead, openings are provided on portions of the common electrodes 9 (so as to allow for hollowing out of the contact holes 5 to the bottom-most layer of the auxiliary common electrode wires 3 later on). This allows for the formation of the contact holes 5 simultaneously with the photopatterning of the interlayer insulating film 11. Thereafter, the contact electrode pads 17 that electrically connect the common electrodes 9 with the auxiliary common electrode wires 3 are formed at the time when the pixel electrodes 13 are formed. This enables the manufacture of the active matrix substrate by use of the five masks. Moreover, the arrangement having no auxiliary common electrode wires does not require the foregoing processes, and is of a five-mask process. This is because the photopatterning step of the contact holes 5 carried out before the formation of the sources and the drains is originally not included.

### Sixth Preferred Embodiment

In the preferred embodiment shown in FIG. 2, the pixel electrodes preferably have a straight comb shape. In comparison, the sixth preferred embodiment adds a change in a shape of the pixel electrodes 13.

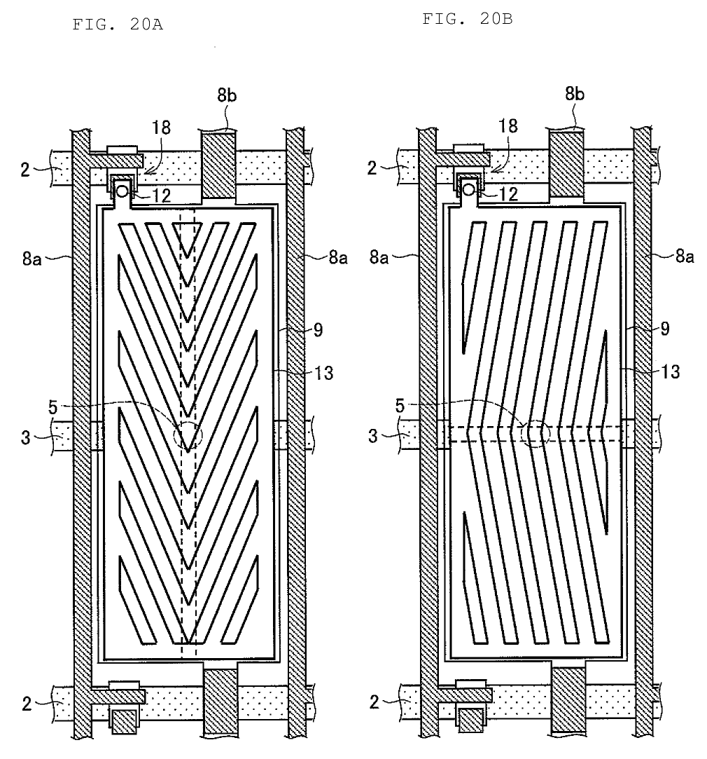

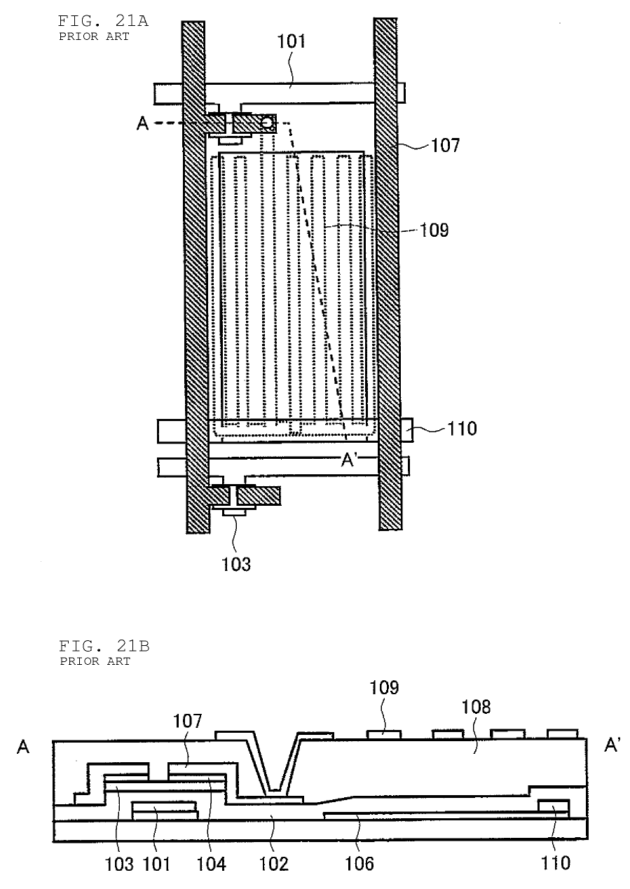

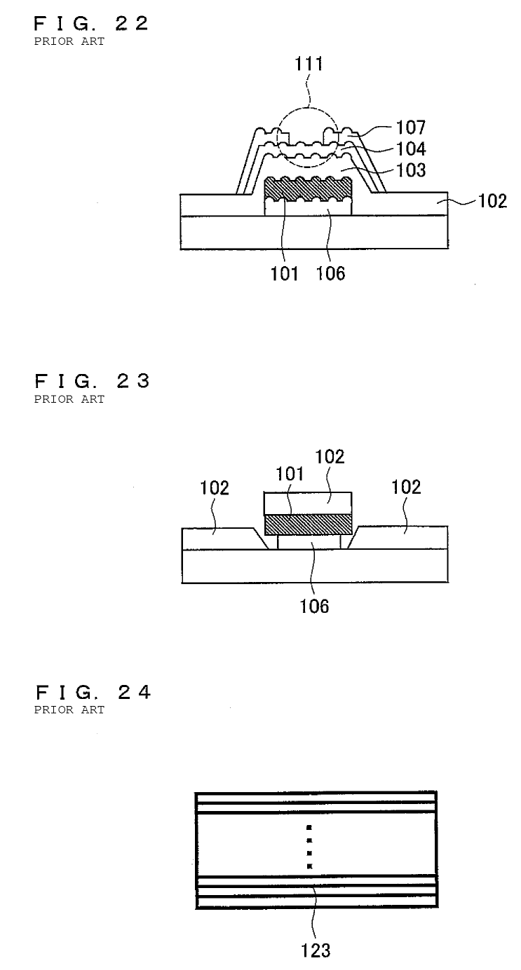

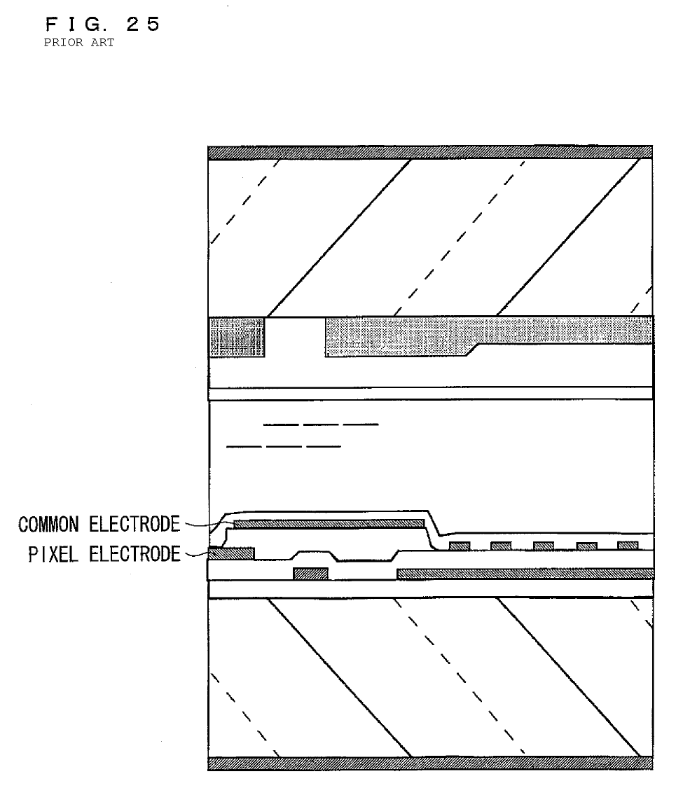

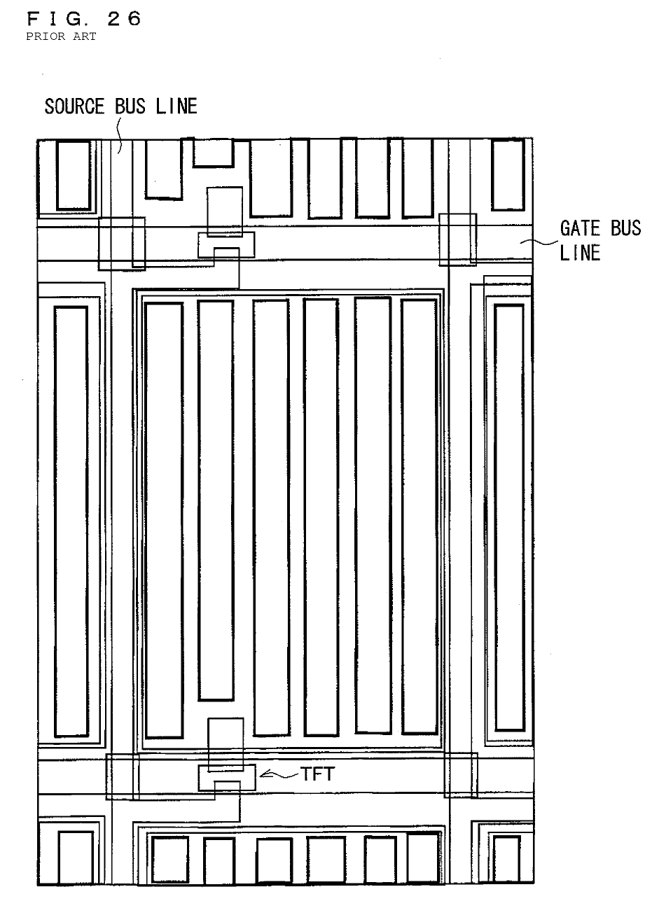

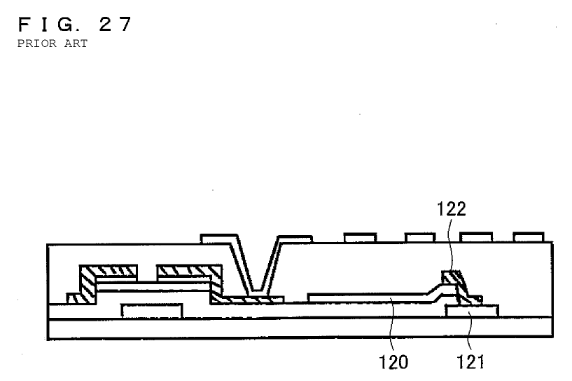

For example, the pixel electrodes 13 may be of a V-shape whose center is positioned between two adjacent ones of the source wires 8a in the pixel areas, as illustrated in FIG. 20A. The pixel electrode 13 may be of a V-shape whose center is positioned at a midpoint between two adjacent ones of the gate wires 2 in the pixel areas. Note that the present modification has the metal layer 21 which is the upper layer of the sources 8a remaining on the common electrodes 9 in areas in which a liquid crystal domain may occur. That is to say, as illustrated in FIGS. 20A and 20B, the metal layer 21 is provided on portions of the common electrodes 9 (broken line section in FIGS. 20A and 20B).

Having the pixel electrodes 13 in such a shape allows for realization of a multi-domain broad angle of view.

As described above, an active matrix substrate according to preferred embodiments of the present invention include an insulating substrate, video signal lines and scanning signal lines provided intersecting with each other on the insulating substrate, and thin film transistors provided at intersections of the video signal lines and the scanning signal lines. The thin film transistors include gate electrodes, source electrodes, and drain electrodes, respectively, a transparent electrode layer, arranged to be used as a lower layer of the source electrodes and the drain electrodes, being used as (i) common electrodes provided in pixel areas surrounded by adjacent video signal lines and adjacent scanning signal lines, respectively and (ii) common electrode wires arranged to connect adjacent ones of the common electrodes parallel to the video signal lines.

Therefore, it is possible to provide an active matrix substrate which is reduced in signal delay caused by resistance and signal delay caused by parasitic capacitance.

Preferred embodiments of the present invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The present invention is applicable to a liquid crystal display device, and is particularly suitable for use in large-screen televisions and the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-13. (canceled)

14. An active matrix substrate comprising:
an insulating substrate;
video signal lines and scanning signal lines arranged to intersect with each other on the insulating substrate;
thin film transistors provided at intersections of the video signal lines and the scanning signal lines, the thin film transistors including gate electrodes, source electrodes, and drain electrodes, respectively; and
a transparent electrode layer, arranged to be used as a lower layer of the source electrodes and the drain electrodes; wherein
the transparent electrode layer is being used as (i) common electrodes provided in pixel areas surrounded by adjacent video signal lines and adjacent scanning signal lines, respectively, and (ii) common electrode wires arranged to connect adjacent ones of the common electrodes parallel or substantially parallel to the video signal lines.

15. The active matrix substrate as set forth in claim 14, wherein:
a metal film defining the gate electrodes is used to define auxiliary common electrode wires that are provided parallel or substantially parallel to the scanning signal lines; and
the auxiliary common electrode wires and the common electrodes are electrically connected to each other via contact holes.

16. The active matrix substrate as set forth in claim 15, wherein:
each of the common electrodes has an opening section having first end sections and second end sections that are located outside and inside, respectively, of an outer edge of a respective one of the contact holes; and
contact electrode pads connected to (i) the auxiliary common electrode wires on the first end sections side of the common electrodes, and (ii) the common electrodes on the second end sections side of the common electrodes, respectively.

17. The active matrix substrate as set forth in claim 16, wherein:
the pixel areas include pixel electrodes; and
the contact electrode pads are made of a same material and in a same manufacturing step as the pixel electrodes.

18. The active matrix substrate as set forth in claim 15, wherein the auxiliary common electrode wires are located substantially at a midpoint between adjacent ones of the scanning signal lines, respectively.

19. The active matrix substrate as set forth claim 15, wherein the auxiliary common electrode wires are located in a vicinity of one of adjacent ones of the scanning signal lines.

20. The active matrix substrate as set forth in claim 15, wherein the auxiliary common electrode wires extend to outer peripheral sections of the common electrodes, and extend in the outer peripheral sections so as to be parallel or substantially parallel to the video signal lines, respectively.

21. The active matrix substrate as set forth in claim 20, wherein the auxiliary common electrode wires also extend to the outer peripheral sections of the common electrodes, and extend in the outer peripheral sections so as to be parallel or substantially parallel to the scanning signal lines, respectively.

22. The active matrix substrate as set forth in claim 14, wherein a metal layer is arranged to surround outer peripheries of the common electrodes, and the metal layer is stacked to define an upper layer of the source electrodes and the drain electrodes.

23. The active matrix substrate as set forth in claim 22, wherein the metal layer is disposed on portions on which the common electrode wires are provided.

24. The active matrix substrate as set forth in claim 14, wherein a metal layer is provided at intersections of the common electrode wires and the scanning signal lines.

25. The active matrix substrate as set forth in claim 14, further comprising an interlayer insulating film including at least two layers, the at least two layers including a layer of an inorganic film and a layer of a low dielectric constant organic material.

26. A liquid crystal display device comprising an active matrix substrate as set forth in claim 14.
